(19) United States
(12) Patent Application Publication
(10) Pub. No.: US 2017/0222492 A1
(43) Pub. Date: Aug. 3, 2017

(54) METHODS AND APPARATUS FOR MAGNETICALLY COUPLED WIRELESS POWER TRANSFER

(71) Applicant: Elix Wireless Charging Systems Inc., Richmond (CA)

(72) Inventors: Vitali TIKHOMOLOV, Vancouver (CA); Brice JAMIESON, Richmond (CA)

(21) Appl. No.: 15/433,960

(22) Filed: Feb. 15, 2017

Related U.S. Application Data
(63) Continuation of application No. PCT/CA2015/050763, filed on Aug. 13, 2015.
(60) Provisional application No. 62/038,102, filed on Aug. 15, 2014.

(51) Int. Cl. H02J 50/90; H02J 7/02; B60L 11/18; H02J 50/10

(52) U.S. Cl. CPC H02J 50/90; H02J 50/10; H02J 7/025; B60L 11/182

(57) ABSTRACT

Transmitter and receiver magnetic rotors are provided wherein each of the rotors comprises a plurality of magnets. Each magnet has a magnetization direction which lies normal to the axis of rotation, and at least some magnetization directions are non-parallel with other magnets' magnetization directions. The magnetization direction of a magnet may be at an offset angle relative to adjacent magnets. The transmitter and receiver may be symmetry about a bisecting plane, and the receiver's magnetization directions may correspond to a rotation of the transmitter's magnetizations directions about an axis parallel to the transmitter's axis of rotation. The magnets in the transmitter and receiver are oriented to reduce rotor vibration due to magnetic coupling between the rotors.

### REFERENCE TO RELATED APPLICATIONS

This application is a continuation of Patent Cooperation Treaty application No. PCT/CA2015/050763 filed 13 Aug. 2015 and entitled METHODS AND APPARATUS FOR MAGNETICALLY COUPLED WIRELESS POWER TRANSFER, which in turn claims priority from, and the benefit under 35 USC §119 of, US provisional application No. 62/038102 filed 15 Aug. 2014 and entitled METHOD AND APPARATUS FOR A MAGNETICALLY COUPLED WIRELESS POWER TRANSFER SYSTEM. All of the patent applications referred to in this paragraph are hereby incorporated herein by reference.

### TECHNICAL FIELD

This disclosure relates to methods and apparatus for magnetically coupled wireless power transfer.

### BACKGROUND

Power can be wirelessly conveyed from one place to another using the Faraday effect, whereby a changing magnetic field causes an electrical current to flow in an electrically isolated secondary circuit. A form of wireless power transfer (WPT) currently in use involves magnetic inductive charging. One form of magnetic inductive charging is shown in WPT system 10 of FIG. 1. The FIG. 1 WPT system 10 comprises two coils 12, 14 in close proximity but separated by an air gap 16. One coil 12 of WPT system 10 acts as a wireless power transmitter and the other coil 14 acts as the receiver of wireless power. A time-varying current flows in transmitter coil 12, which produces a time-varying magnetic field (shown as flux lines in FIG. 1). This time-varying magnetic field induces current in the nearby receiver coil 14 (Faraday's law), which can then be used to charge various devices (not shown) which may be electrically connected to receiver coil 14.

In PCT application No. PCT/CA2010/000252 (published under WO/2010/096917), a magnetic-coupling technology has been described to provide a number of viable WPT systems that can be used to charge, by way of non-limiting example, batteries generally, electric (e.g. battery operated) vehicles, auxiliary batteries, electric (e.g. battery operated) buses, golf carts, delivery vehicles, boats, drones, trucks and/or the like. FIG. 2 schematically depicts a WPT system 20 incorporating a magnetic-coupling technology of the type described in PCT/CA2010/000252. WPT system 20 comprises a wireless magnetic power transmitter 22 and a wireless magnetic power receiver 24 separated by an air gap 26. The power transfer in WPT system 20 is via rotational magnetic coupling rather than via direct magnetic induction. In the FIG. 2 WPT system 20, transmitter 22 comprises a permanent magnet 22A and receiver 24 comprises a permanent magnet 24A. Transmitter magnet 22A is rotated (and/or pivoted) about axis 28. The magnetically coupled permanent magnets 22A, 24A interact with one another (magnetic poles represented by an arrow with notations of “N” for north and “S” for south in FIG. 2), such that movement of transmitter magnet 22A about axis causes corresponding movement (e.g. rotation and/or pivotal movement) of receiver magnet 24A about axis 27. The time-varying magnetic fields generated by rotating/pivoting magnets 22A, 24A of WPT system 20 typically has a lower frequency compared to WPT systems based on magnetic induction.

In a magneto-dynamically coupled system, such as that illustrated in FIG. 2, the attractive force between the transmitter and receiver magnetic rotors varies with the angular position of each rotor around its axis of rotation. During a full rotation of each rotor, the transmitter and receiver magnets 22A, 24A will each align in such a way that both will experience a varying force (caused by the other one of the transmitter and receiver magnets 22A, 24A) along an axis perpendicular to both of their rotational axes 28. This force will reach two maxima and two minima per 360° rotation, making this force twice-per-cycle (twice-per-full rotor rotation) periodic. This force variation may cause the transmitter and receiver rotors to vibrate, thereby causing undesired effects. These undesired effects may include, for example: higher noise emitted by transmitter 22 and receiver 24, faster rotor-supporting bearing wear, limitation of rotor operating speed, and/or transfer of vibration to surrounding structures (e.g. supports, mounts and/or the like). There is a general desire for magneto-dynamically coupled power transfer methods and apparatus which can ameliorate at least some of these deficiencies.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a magnetically-coupled wireless power transfer system, comprising: a wireless power transmitter rotor comprising a plurality of transmitter magnets each having a magnetization direction, the transmitter rotor rotatable about a transmitter axis and the plurality of transmitter magnets arranged adjacent to one another along the transmitter axis; and a wireless power receiver rotor comprising a plurality of receiver magnets each having a magnetization direction, the receiver rotor rotatable about a receiver axis and the plurality of receiver magnets arranged adjacent to one another along the receiver axis, the receiver rotor positionable in a power transfer position relative to the transmitter rotor. While the receiver rotor is in the power transfer position relative to the transmitter rotor, the transmitter rotor and receiver rotor are spaced apart by an air gap and magnetically attracted to one another, so that rotation of the transmitter rotor causes opposing rotation of the receiver rotor. A first one of the plurality of the transmitter magnets has a first magnetization direction and a second one of the plurality of transmitter magnets has a second magnetization direction, the second magnetization direction non-parallel with the first magnetization direction so that, while the receiver rotor is in the power transfer position relative to the transmitter rotor and the transmitter rotor rotates about the transmitter axis, magnetic attraction of the first transmitter magnet to the receiver rotor is maximized at a first rotational position of the transmitter rotor about the transmitter axis and magnetic attraction of the second transmitter magnet to the receiver rotor is maximized at a second rotational position of the transmitter rotor about the transmitter axis different than the first rotational position.

Another aspect of the invention provides a magnetically-coupled wireless power transfer system, comprising: a wireless power transmitter comprising a plurality of transmitter magnets each having a magnetization direction, the plurality of transmitter magnets rotatable about a transmitter axis and arranged adjacent to one another along the transmitter axis; and a wireless power receiver comprising a plurality of receiver magnets each having a magnetization direction, the plurality of receiver magnets rotatable about a receiver axis and arranged adjacent to one another along the receiver axis, the wireless power receiver positionable in a power transfer position relative to the wireless power transmitter. While the wireless power receiver is in the power transfer position relative to the wireless power transmitter, the wireless power transmitter and wireless power receiver are spaced apart by an air gap and magnetically attracted to one another so that rotation of the wireless power transmitter causes opposing rotation of the wireless power receiver;. A first one of the plurality of the transmitter magnets has a first magnetization direction and a second one of the plurality of transmitter magnets has a second magnetization direction, the second magnetization direction non-parallel with the first magnetization direction so that, while the wireless power receiver is in the power transfer position relative to the wireless power transmitter and the plurality of transmitter magnets rotates about the transmitter axis, magnetic attraction of the first transmitter magnet to the wireless power receiver is maximized at a first rotational position and magnetic attraction of the second transmitter magnet to the wireless power receiver is maximized at a second rotational position different than the first rotational position.

Another aspect of the invention provides a magnetically-coupled wireless power transfer system comprising: a transmitter rotor further comprising at least two magnets connected end-to-end and further arranged such that the magnetization directions of each of the magnets are offset by a defined angle with respect to each other; and a receiver rotor further comprising at least two magnets connected end-to-end and further arranged such that the magnetization directions of each of the magnets are offset by a defined angle with respect to each other.

Another aspect of the invention provides a method for wireless transferring power from a transmitter rotor to a receiver rotor. The method comprises: providing a wireless power transmitter rotor comprising a plurality of transmitter magnets each having a magnetization direction, the transmitter rotor rotatable about a transmitter axis and the plurality of transmitter magnets arranged adjacent to one another along the transmitter axis; providing a wireless power receiver rotor comprising a plurality of receiver magnets each having a magnetization direction, the receiver rotor rotatable about a receiver axis and the plurality of receiver magnets arranged adjacent to one another along the receiver axis. The method also comprises: bringing the receiver rotor into proximity with the transmitter rotor; and rotating the transmitter rotor about the transmitter axis to thereby cause opposing rotation of the receiver rotor about the receiver axis. A first one of the plurality of the transmitter magnets has a first magnetization direction and a second one of the plurality of transmitter magnets has a second magnetization direction, the second magnetization direction non-parallel with the first magnetization direction so that, during rotation of the transmitter rotor about the transmitter axis, magnetic attraction of the first transmitter magnet to the receiver rotor is maximized at a first rotational position of the transmitter rotor about the transmitter axis and magnetic attraction of the second transmitter magnet to the receiver rotor is maximized at a second rotational position of the transmitter rotor about the transmitter axis different than the first rotational position.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is prior art illustrating the principle of magnetic inductive charging by a power transmitter coil and a wireless power receiver coil in close proximity.

FIG. 2 is prior art illustrating the principle of magnetically-coupling two rotating magnets in a wireless power transfer system.

FIG. 3A depicts example transmitter and receiver magnet rotors comprising a plurality of magnets.

FIG. 3B depicts example end caps for the example rotors of FIG. 3A as seen when viewed along the rotors' axes of rotation.

FIG. 4 graphically illustrates the forces experienced by an example single magnet and an example three-magnet rotor.

FIG. 5A graphically illustrates the relative angular positions of the magnets of the transmitter and receiver magnet rotors of FIG. 3A.

FIG. 5B graphically illustrates the relative angular positions of the magnets of an example 5-magnet transmitter magnet rotor.

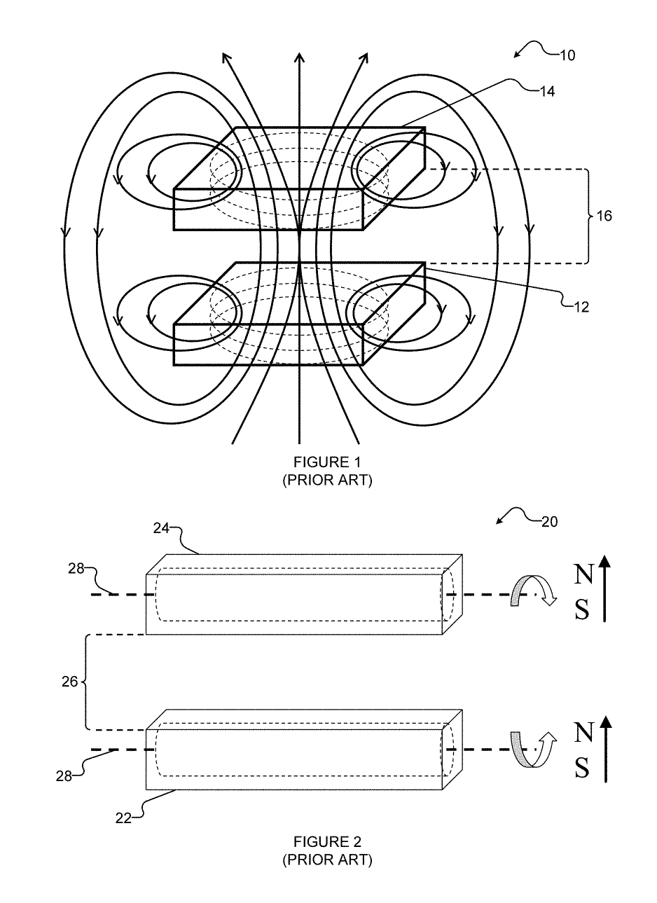

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Embodiments of the present disclosure provide apparatus and methods for magnetically-coupled wireless power transfer. Magnetically coupled wireless power transfer systems comprise transmitter and receiver magnetic rotors, where each of the rotors comprises a plurality of magnets. Each magnet has a total magnetic moment which lies normal to the axis of rotation, at some angle from the adjacent magnets in the same rotor. The magnets in the transmitter and receiver rotors may be oriented to reduce rotor vibration due to magnetic coupling between the rotors relative to the rotor vibration typically experienced by conventional single-magnet-per-rotor magneto-dynamically coupled systems.

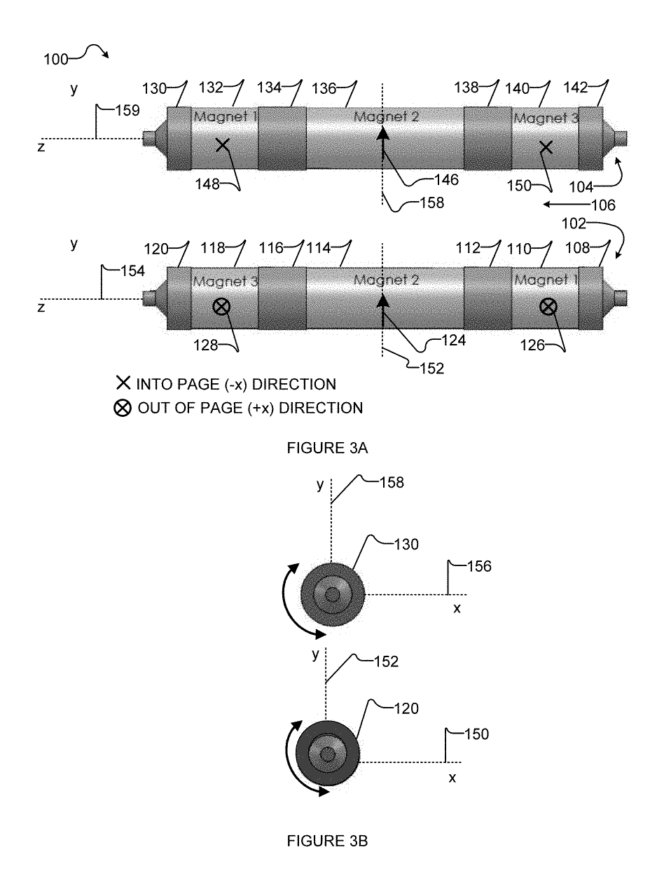

FIGS. 3A and 3B (collectively and individually FIG. 3) schematically depict a magnetically coupled wireless power transfer system 100 according to a particular embodiment. System 100 comprises a generally cylindrical transmitter magnet rotor 102 (also referred to herein as “transmitter rotor 102” or simply “transmitter 102”) and a generally cylindrical receiver magnet rotor 104 (also referred to herein as “receiver rotor 102” or simply “receiver 104”), each comprising a plurality of magnets. In the example embodiment FIG. 3, transmitter rotor 102 and receiver rotor 104 are separated by an air gap 106. Transmitter rotor 102 and receiver rotor 104 are positioned with their respective cylindrical rotation axes 154, 159 approximately parallel to each other and spaced apart at a distance which enables coupling between transmitter and receiver rotors 102, 104 by corresponding magnetic fields—this relative position of transmitter and receiver rotors 102, 104 is referred to herein as a power transfer position. Such magnetic coupling transfers torque from one rotating rotor (transmitter rotor 102) to another (receiver rotor 104). Transmitter rotor 102 may, for example, be a component of a wireless charging station, and receiver rotor 104 may, for example, be a component of a wireless power receiver system. The wireless power receiver system may be located in, for example, an electric vehicle, a portable electronic device, and/or other mobile platforms or applications. Though not shown in the schematic view of FIG. 3, the transmitter and receiver magnet rotors 102, 104 are typically placed inside of a protective housing where they are supported for rotation about their respective axes 154, 159.

Each of transmitter and receiver rotors 102, 104 may comprise a plurality of magnets arranged adjacent to one another along their respective axes 154, 159 of rotation. In some embodiments, at least some of the magnets in one or both of transmitter and receiver rotors 102, 104 are spaced apart from adjacent magnets in the direction of their respective axes 154, 159 of rotation. The magnets may be spaced apart by suitable spacers, such as non-magnetic fittings and/or the like. In some embodiments, at least some of the magnets in one or both of transmitter and receiver rotors 102, 104 are axially abutting (i.e. they are not spaced apart from adjacent magnets in the direction of their respective axes 154, 159 of rotation). The magnets may be permanent, electromagnetic, and/or any other suitable magnetic field generating unit.

In some embodiments (such as the embodiment depicted in FIG. 3), transmitter rotor 102 comprises three magnets 110, 114, 118 retained between axially-opposing end caps 108, 120. Magnets 110, 114, 118 of the illustrated embodiment are axially spaced apart and rigidly held in place by connector fittings 112, 116, which may be non-magnetic. For reasons discussed in greater detail below, axially central magnet 114 may be about twice as large (in the axial direction) as either of the end magnets 110 and 118 in embodiments with an odd number of magnets. Doubling the axial dimension of axially central magnet 114 may provide transmitter rotor 102 with symmetry about a bisecting plane as explained below.

Transmitter rotor 102 rotates about a rotational axis 154 (also referred to as “transmitter axis 154). Transmitter axis 154 may be labelled as a Cartesian z-axis (as is the case in FIG. 3). The rotation of transmitter rotor 102 may be described by reference to its angular position about transmitter axis 154 in a plane orthogonal to rotational axis 154. For the sake of convenience, we define herein first and second orthogonal axes 150, 152 which are orthogonal to rotational axis 154 of transmitter rotor 102 and to each other. These orthogonal axes 150, 152 may be labelled as Cartesian x and y axes (as shown in FIG. 3B). It will be appreciated that these orthogonal axes 150, 152 are used herein as a matter of convenient reference. In FIG. 3A, axes 152 and 154 are in the plane of the page and therefore visible and axis 150 extends into and out of the page and is therefore not visible. In FIG. 3B, axes 150 and 152 are in the plane of the page and therefore visible and axis 154 extends into and out of the page and is therefore not visible.

Similarly, in some embodiments (including the depicted embodiment of FIG. 3), receiver rotor 104 comprises three magnets 132, 136, 140 retained between axially-opposing end caps 130, 142. Magnets 132, 136, 140 of the illustrated embodiment are axially spaced apart and rigidly held in place by connector fittings 134, 138, which may be non-magnetic. For reasons discussed in greater detail below, axially central magnet 136 may be about twice as large (in the axial direction) as either of the end magnets 132 and 140 in embodiments with an odd number of magnets. Doubling the axial dimension of axially central magnet 136 may provide receiver rotor 104 with symmetry about a bisecting plane as explained below. Receiver rotor 104 is supported for rotation about rotational axis 159 (also referred to as “receiver axis 159”), and first and second orthogonal axes 156, 158 (see FIG. 3B) may be defined for convenience to describe the rotation of receiver rotor 104 about its rotational axis 159. As shown in FIGS. 3A and 3B, rotational axis 159 may be oriented along a Cartesian z-axis and orthogonal axes 156, 158 may correspond to Cartesian x- and y-axes. Unless the context or description indicates otherwise, the description herein of transmitter rotor 102 and its characteristics is generally also applicable to receiver rotor 104 and its characteristics, with appropriate changes in reference numerals and nomenclature and vice versa.

FIG. 3B provides an end view of transmitter and receiver rotors 102, 104 and thus shows end caps 120, 130. In some embodiments, including the depicted embodiment, transmitter rotor 102 has a cylindrical design that can rotate in either angular direction about its rotation axis 154 (as represented by the double-headed arrow shown in FIG. 3B) depending on the requirements of the wireless power transfer system 100.

In some embodiments, each magnet in transmitter and receiver rotors 102, 104 comprises a magnetization direction that is non-parallel relative to the magnetization direction(s) of one or more of the other magnets in its corresponding rotor 102, 104. For example, the magnetization directions of some magnets in transmitter and receiver rotors 102, 104 may be offset relative to one another by an offset angle θ about their respective rotation axis 154, 159. In some embodiments, each magnet in transmitter and receiver rotors 102, 104 is offset from any axially adjacent magnets by the offset angle θ about its respective rotation axis 154, 159 (although, in some embodiments, axially central magnets may optionally not be so offset).

In some three-magnet embodiments, such as the embodiment of FIG. 3, the magnets 110, 114, 118 of transmitter rotor 102 have magnetization directions 126, 124, 128, respectively (denoted m_{1A}, m_{2A}, m_{3A}, respectively), which may be nonparallel and, in particular, may have different angular orientations about rotation axis 154. In some embodiments (such as the depicted embodiment of FIG. 3), the magnetization direction of a given magnet (e.g. magnetization direction 124 of magnet 114) about rotational axis 154 is offset by an offset angle θ from the magnetization direction(s) of its axially adjacent magnet(s) (e.g. magnetization directions 126, 128 of magnets 110, 118, respectively) about rotational axis 154. For example, an offset angle of θ=90° has been found to be particularly effective at reducing vibrational transfer in at least some three-magnet embodiments, although other offset angles are possible. For instance, if magnet 110 has a magnetization direction of 0° about rotation axis 154 (which may be assumed without loss of generality), then magnets 114 and 118 may have magnetization directions of 90° and 0°, respectively, about rotation axis 154.

Example magnetization directions 124, 126, 128 of magnets 110, 114, 116 are illustrated in FIG. 3 with the use of direction symbols. Magnetization direction 124 of axially central magnet 114 is represented by an arrow indicating its direction; in the depicted embodiment, it is directed along y-axis 152. Magnetization directions 126 and 128 of first and third magnets 110, 118, respectively, are both directed out of the page (indicated by the circled “x”), and thus are offset by about θ=90° (about rotation axis 154) relative to the magnetization direction 124 of axially central magnet 114. In the arbitrarily-chosen frame of reference defined by axes 150, 152, magnetization directions 126 and 128 are directed along x-axis 150.

Similarly, magnets 132, 136, 140 of receiver rotor 104 of the three-magnet embodiment depicted in FIG. 3 have magnetizations directions 148, 146, 150, respectively (denoted m_{1B}, m_{2B}, m_{3B}, respectively). In the depicted orientation of rotors 102, 104, magnetization directions 124 and 146 of axially central magnets 114 and 136 are correspondingly aligned so that they are directed in substantially the same direction, thereby causing magnets 124 and 146 to attract one another. In the illustrated embodiment, magnetization directions 148, 150 are both directed into the page (indicated by the uncircled “x”), and thus are offset by about θ=90° (about rotation axis 154) relative to the magnetization direction 146 of axially central magnet 136. In the arbitrarily-chosen frame of reference defined by axes 156, 158, magnetization directions 148 and 150 are directed along x-axis 156 (in the negative x-direction), and are thus substantially parallel to and opposing magnetization directions 126 and 128 of the first and third magnets 110, 118 of transmitter rotor 102. Of course, other orientations of rotors 102, 104 are possible as they rotate about their respective rotational axes 154, 159, but the example rotors will eventually arrive at the depicted orientation given sufficient rotation.

In some embodiments (including the embodiment of FIG. 3), the arrangements and/or orientations of magnets 110, 114, 118 of transmitter rotor 102 and magnets 132, 136, 140 of receiver rotor 104 are not exactly alike. For example, in some embodiments, the orientations of magnetizations directions 146, 148, 150 are approximately equal to a 180° rotation of magnetization directions 124, 126, 128 about y-axis 152, which bisects transmitter rotor 102 along its rotational axis 154. That is, the orientations of magnetization directions 146, 148, 150 of the magnets in receiver rotor 104 may be obtained by rotating transmitter rotor 102 end-to-end about an axially bisecting y-axis 152. This reversal accounts for the fact that rotation of transmitter rotor 102 in a particular angular direction about its rotation axis 154 will cause rotation of receiver rotor 104 in an opposing angular direction about its rotation axis 159. If the magnets of transmitter rotor 102 and receiver rotor 104 had the same magnetization directions, rotation about their respective axes 154, 159 in opposing directions would likely result in a net repulsive force at some angles of rotation and in a net attractive force at other angles of rotation. This would reinforce vibrational transfer between rotors 102, 102, which is generally undesirable.

In some embodiments, the magnetization directions 124, 126, 128 of transmitter rotor 102 are symmetric about a bisecting plane that bisects its rotational axis 154. For example, transmitter rotor 102 of the example FIG. 3 embodiment is symmetric about a bisecting (x-y-oriented) plane orthogonal to rotational axis 154 and coincident with axially bisecting y-axis 152, so that first magnet 110 (and its magnetization direction 126) are symmetric with third magnet 118 (and its magnetization direction 128) about the bisecting plane. Axially central magnet 114 may be considered to be symmetric with itself about the bisecting plane. In some embodiments the bisecting plane does not pass through a magnet (e.g. in symmetric embodiments with an even number of magnets). In such embodiments, the centermost pair of magnets flanking the bisecting plane may be symmetric with each other, even though such magnets may be considered to be axially adjacent to each other (and thus would be adjacent magnets without offset magnetization directions).

In some embodiments, including some symmetric embodiments (such as the embodiment of FIG. 3), the magnetization directions of the magnets on transmitter rotor 102 may optionally be monotonically increasing or decreasing over at least a subset of the magnets of transmitter rotor 102. For example, if the magnetization directions of the magnets of transmitter rotor 102 are arranged in an end-to-end order {m_{1A}, m_{2A}, . . . , m_{nA}} such that m_{iA} and m_{(i+1)A} are axially adjacent for each i, then each m_{iA} may be offset from M_{(i+1)A} by the offset angle θ in the same angular direction (e.g. clockwise or counterclockwise) for some sub-sequence of adjacent magnetization directions {m_{iA}}. For instance, m_{1A} may have an orientation of 0°, m_{2A} may be offset from m_{1A} by 90° clockwise, m_{3A} may be offset from m_{2A} by 90° clockwise (and thus offset from m_{1A} by 180° clockwise) and so on, up to m_{jA}.

In some symmetric embodiments, the magnetization directions of axially adjacent magnets on one side of the bisecting plane of transmitter rotor 102 may optionally be monotonically increasing or decreasing—that is, for each pair of axially adjacent magnets, the magnetization direction of the magnet nearer the bisecting plane may be offset in the same direction relative to the magnetization direction of the magnet further from the bisecting plane. Due to symmetry, the magnetization directions of magnets on the other side of the bisecting plane will each be offset from the magnetization directions of their axially adjacent magnets in the opposing direction. For example, continuing the above example, M_{(j+1)A} may be offset from m_{jA} by 90° counterclockwise (or, in an embodiment with an even number of magnets, m_{jA} and m_{(j+1)A} may have the same magnetization direction and both may be offset from m_{(j+2)A} by 90° counterclockwise), and so on up to m_{nA}. An example of such an embodiment is shown in FIG. 3, where magnetization direction 126 of first magnet 110 is offset from magnetization direction 124 of second magnet 114 by 90° in one direction (e.g. clockwise), and magnetization direction 124 of second magnet 114 is offset from magnetization direction 128 of third magnet 118 by 90° in the opposing direction (e.g. counterclockwise).

The same example magnetization directions 124, 126, 128 (m_{2A}, m_{1A}, m_{3A}) of magnets 110, 114, 116 shown in FIG. 3 are also illustrated in FIG. 5A, which graphically represents the relative orientations of magnetization directions 124, 126, 128 (m_{2A}, m_{1A}, m_{3A}) of the magnets of transmitter rotor 102 about transmitter axis 154 and magnetization directions 146, 148, 150 (m_{2B}, m_{1B}, m_{3B}) of the magnets of receiver rotor 104 about receiver axis 159. For the sake of comparison, x- and y-axes 156 and 158 (associated with receiver rotor 104) are superimposed on x- and y-axes 150, 152 (associated with transmitter rotor 102). As discussed above, magnetization directions 126 and 128 (m_{1A} and m_{3A}) of transmitter rotor 102 are substantially aligned, and are offset from magnetization direction 124 (m_{2A}) of transmitter rotor 102 by offset angle 180 (denoted θ) which, in this example, is θ=90°. Magnetization directions 150, 148 (m_{1B} and m_{3B}) of receiver rotor 104 are similarly offset from magnetization direction 146 (m_{2B}) of transmitter rotor 104 by offset angle 182 (which, in this embodiment, is equal in magnitude to offset angle 180 and also denoted θ), but which has the opposite angular offset direction relative to angular offset between the magnetization directions 124, 126, 128 of transmitter rotor 102. Magnetization directions 150, 148 of receiver rotor 104 correspond to magnetization directions 126, 128 of transmitter rotor 102 rotated end-to-end (i.e. 180°) about axially bisecting y-axis 152, as described above.

Although the example embodiment of FIG. 3 provides only three magnets in transmitter rotor 102, in some embodiments transmitter rotor 102 comprises any of two or more magnets. The offset angle θ between the magnetization directions of axially adjacent magnets of transmitter rotor 102 may generally vary in a range of −180°<θ≦180°. In some embodiments, where transmitter rotor 102 comprise three or more magnets, the offset angle θ between the magnetization directions of axially adjacent magnets may vary in a range of −90°<θ≦90°.

For example, FIG. 5B shows the angular positions of magnetization directions 160, 162, 164, 166, 168 (denoted m_{1A}, m_{2A}, m_{3A}, m_{4A}, M_{5A}, respectively) of a five-magnet embodiment of transmitter rotor 102. Magnetization directions 160 and 162 are offset by offset angle 190, as are magnetization directions 166 and 168 (although in the opposite direction). Similarly, magnetization directions 162 and 164 are offset by offset angle 192, as are magnetization directions 164 and 166 (although in the opposite direction). Thus, magnetization direction 164 (m_{3A}) is offset from m_{1A} and m_{5A} by a total angle φ=2θ. In the embodiment illustrated by FIG. 5B, offset angles 190 and 192 (both denoted θ) are 60°, although other offset angles may be used. Although a receiver rotor 104 is not shown in FIG. 5B, its magnetization directions may be derived by rotating magnetization directions 160, 162, 164, 166, 168 by 180° about axially bisecting y-axis 152, as described above.

In some embodiments, the offset angle θ between the magnetization directions of a pair of axially adjacent magnets in transmitter rotor 102 and/or receiver rotor 104 is determined based on the number of magnets m in the respective rotor 102, 104. This determination may be different depending on whether the number of magnets m is even or odd. For example, for an odd number of magnets m, the offset angle θ may be determined according to the following formula:

$$θ = \frac{360 °}{m + 1} \qquad ( 1 )$$

Thus, for example, in a three-magnet system (e.g. the FIG. 3 embodiment) θ=90°, in a five-magnet system (e.g. the FIG. 5B embodiment) θ=60°, and so on. As another example, for an even number of magnets m, the offset angle θ may be determined according to the following formula:

$$θ = \frac{360 °}{m} \qquad ( 2 )$$

Thus, for example, in a two-magnet system θ=180°, in a four-magnet system θ=90°, and so on.

As described in the preceding paragraphs and illustrated in FIG. 3, the magnets that comprise the transmitter and receiver rotors may be placed end-to-end in specific arrangements such that their magnetization directions are offset by a regular amount (e.g. an offset angle θ) between each pair of adjacent magnets. The transmitter and receiver magnets may be further aligned with respect to each other (e.g. by 180° rotation about axially bisecting y-axis 152, as described above) to create a magnetically balanced system. For example, in the embodiment illustrated in FIG. 3, the magnetization directions of the axially central magnets of transmitter and receiver rotors 102, 104 may be aligned in substantially the same direction while the magnetization directions of the end magnets 110 and 118 in transmitter magnet rotor 102 and the end magnets 132 and 140 in receiver magnet rotor 104 are aligned in substantially opposite directions. This arrangement corresponds to 180° rotation about axially bisecting y-axis 152. Two such rotors 102 and 104 magnetically coupled produce lower vibration than two typical single-magnet, diametrically-magnetized rotors or rotors having other magnetic configurations. This configuration results in relatively smoothed attraction forces between the magnets of rotors 102, 104 and smoothed moment around the rotors' center of mass.

Operationally, magnetically coupled wireless transfer systems comprising the multiple-magnet rotors may reduce vibration by distributing the force between magnets in time and space. Instead of all of the force acting between both rotors at the same time, it is distributed so that the force between each of the torque-pairs of magnets (defined as all of the parallel-magnetized magnets from the transmitter and the corresponding magnets in the receiver) will be twice-per-cycle periodic but offset from the force caused in the remaining torque-pairs. The torque pairs of the example embodiment illustrated in FIG. 3 are paired magnets 110 and 140, paired magnets 114 and 136 and paired magnets 118 and 132 across the air gap 106. With judicious use of alignment, the force from one torque-pair will be dampened by the force from the adjacent torque-pairs.

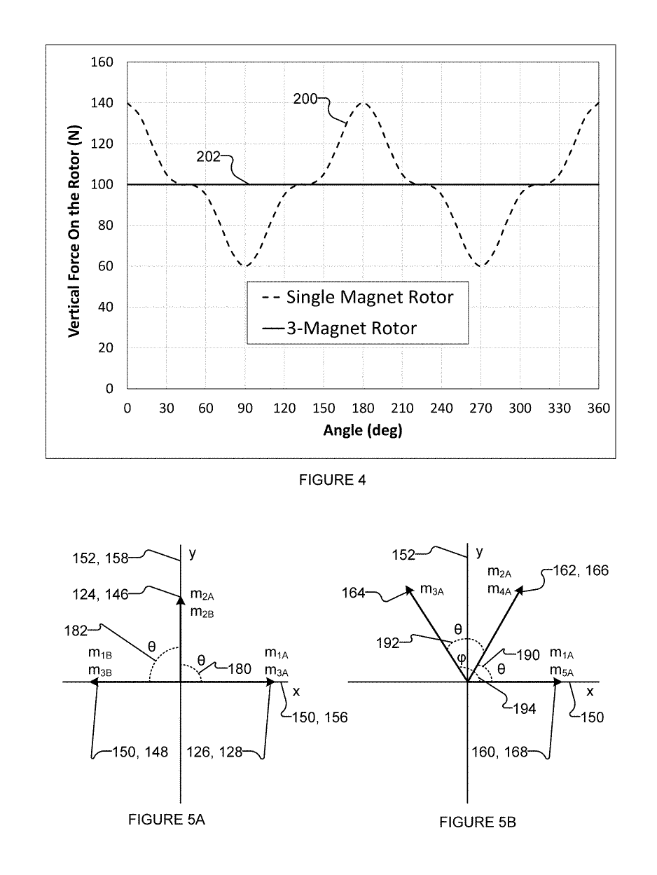

FIG. 4 graphically illustrates the translational force (e.g. in the y-axis direction) on an example pair of single magnet rotors 200 and an example pair of multi-magnet rotors 202 having the configuration of FIG. 3. The x-axis of the FIG. 4 graph is the angular rotation of the rotors from 0° to 360° (i.e. covering one complete rotation). The y-axis of the graph is the resulting translational force (N) on the rotors that is perpendicular to the axis of rotation of the rotors as the rotors are rotated from 0 to 360°. The dotted plot 200 represents the resulting force on two single-magnet, diametrically-magnetized rotors as they are rotated from 0° to 360°. The solid plot 202 represents the resulting force on two multi-magnet rotors 202 having the configuration of FIG. 3.

As can be seen in the graph in FIG. 4, the force experienced by a single-magnet rotor (plot 202) varies substantially with angular rotation. Two force minima are experienced by the rotors at 90° and 270° degree rotation and two force maxima at 0° and 180°, or twice each per rotation. In other words, during a full rotation the transmitter and receiver rotor will each align in such a way that both will experience maximum and minimum translational forces of attraction along an axis perpendicular to both of their rotational axes. This force variation can cause the rotors to vibrate, leading to higher noise emission by the transmitter and receiver rotors, increased bearing wear, and limitation of rotor operating speed which limits their use in high power transfer applications.

In contrast, as can be seen in the graph in FIG. 4, the translational force (plot 202) on transmitter and receiver rotors 102 and 104 of the FIG. 3 embodiment comprising three magnets varies substantially less than the single-magnet forces illustrated by plot 200. FIG. 4 shows that the translational force (plot 202) on the rotors of the FIG. 3 embodiment is relatively more even and smoothed over a complete rotor rotation (from 0° to 360°) when compared to the translation force (plot 200) of single-magnet rotors. Although solid line 202 is depicted as substantially constant along the vertical axis, persons skilled in the art will appreciate that some variation may be experienced by the rotors of the FIG. 3 embodiment.

Such magnetic balancing may contribute to a substantial decrease in rotor vibration, wear and noise emission, which may provide further benefits such as lower maintenance costs and/or longer operating life. Analytical calculations have confirmed that the proposed embodiment described herein and illustrated in FIG. 3 and graphically illustrated in FIG. 4 result in a substantially magnetically balanced rotor system.

Wireless power transfer systems and methods in accordance with various embodiments of the invention described herein may be used in any magnetically-coupled wireless charging system for, but not limited to, electric powered automobiles, transit buses, delivery vehicles, trucks, drones, boats, golf carts or other consumer devices and mobile applications. Wireless power transfer systems and methods in accordance with various embodiments of the invention reduce vibration and noise observed in wireless charging systems with single magnet rotors and allow for high power transfer rates and longer operating life.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof; elements which are integrally formed may be considered to be connected or coupled;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments. In particular:
The above-described embodiments describe symmetric rotors where the angular orientations of the magnetization directions of axially adjacent magnets about the rotor axis increase or decrease monotonically on each side of an axially bisecting plane of symmetry. This is not necessary. In some embodiments, it may be sufficient for the magnetization directions of the magnets in a rotor to be symmetric about the axially bisecting plane of symmetry without increasing or decreasing monotonically. In some embodiments, the angular offsets between the different orientations of the magnetization directions about the rotor axis may still be provided by equation (1) (in the case of an odd number of magnets or equation (2) in the case of an even number of magnets), except that the axial locations of the magnets having these offsets need not be axially adjacent. For example, where the number of magnets is m=5, equation (1) suggests that the offset within the set of magnetization directions may be θ=60°. In the FIG. 5B embodiment, the orientations of the magnetization magnets are m_{1A}=0°, m_{2A}=60°, m_{3A}=120°, m_{4A}=60°, m_{5A}=0°, such that each axially adjacent pair of magnets is offset by θ=60°. In some embodiments, however, the θ=60° spacing within the set of magnetization directions could be achieved by a symmetrical configuration that is not monotonically increasing or decreasing on each side of an axially bisecting plane of symmetry. For example, the orientations of the magnetization magnets could be m_{1A}=0°, m_{2A}=120°, m_{3A}=60°, m_{4A}=120°, m_{5A}=0°.
The above-described embodiments describe symmetric rotors where the angular orientations of the magnetization directions of magnets about the rotor axis are symmetric on each side of an axially bisecting plane of symmetry. This is not strictly necessary. In some embodiments, similar vibration-reducing effects could be achieved where a majority of the plurality of magnets on each side of the axially bisecting plane exhibit this symmetry. For example, in an embodiment with 7 magnets on each side of a an axially bisecting plane, it may be sufficient if 6 of the 7 magnets (or some other majority of the 7 magnets) on each side of the bisecting plane are symmetric with one another.
In the embodiments described above, an angular spacing of orientations in a set of magnetization directions about a rotor axis is provided by equation (1) in the case of an odd number of magnets on a rotor or by equation (2) in the case of an even number of magnets on a rotor. This is not strictly necessary. In other embodiments, other angular spacings could be provided.
In the embodiments described above, the number of magnets in transmitter rotor 102 is equal to the number of magnets in receiver rotor 104. This is not necessary. In some embodiments, similar vibration-reducing effects could be achieved where the number of magnets in a receiver rotor is different than the number of magnets in a transmitter rotor.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A magnetically-coupled wireless power transfer system, comprising:
a wireless power transmitter rotor comprising a plurality of transmitter magnets each having a magnetization direction, the transmitter rotor rotatable about a transmitter axis and the plurality of transmitter magnets arranged adjacent to one another along the transmitter axis;
a wireless power receiver rotor comprising a plurality of receiver magnets each having a magnetization direction, the receiver rotor rotatable about a receiver axis and the plurality of receiver magnets arranged adjacent to one another along the receiver axis, the receiver rotor positionable in a power transfer position relative to the transmitter rotor;
wherein while the receiver rotor is in the power transfer position relative to the transmitter rotor, the transmitter rotor and receiver rotor are spaced apart by an air gap and magnetically attracted to one another, so that rotation of the transmitter rotor about the transmitter axis causes opposing rotation of the receiver rotor about the receiver axis; and
wherein a first one of the plurality of the transmitter magnets has a first magnetization direction and a second one of the plurality of transmitter magnets has a second magnetization direction, the second magnetization direction non-parallel with the first magnetization direction so that, while the receiver rotor is in the power transfer position relative to the transmitter rotor and the transmitter rotor rotates about the transmitter axis, magnetic attraction of the first transmitter magnet to the receiver rotor is maximized at a first rotational position of the transmitter rotor about the transmitter axis and magnetic attraction of the second transmitter magnet to the receiver rotor is maximized at a second rotational position of the transmitter rotor about the transmitter axis different than the first rotational position.

2. A magnetically-coupled wireless power transfer system according to claim 1 wherein:
the first and second transmitter magnets are axially adjacent to one another;
the first and second magnetization directions are offset by a transmitter offset angle about the transmitter axis relative to one another; and
the plurality of receiver magnets comprise first and second receiver magnets spaced apart from the first and second transmitter magnets in a direction orthogonal to the transmitter axis, the first and second receiver magnets being axially adjacent to one another and having magnetization directions offset by a receiver offset angle about the receiver axis relative to one another.

3. A magnetically-coupled wireless power transfer system according to claim 2 wherein the first and second transmitter magnets being axially adjacent to one another comprises the first and second transmitter magnets axially abutting.

4. A magnetically-coupled wireless power transfer system according to claim 2 wherein the first and second transmitter magnets being axially adjacent to one another comprises the first and second transmitter magnets being axially spaced apart in an axial direction, the space between the first and second transmitter magnets being unoccupied by any other magnet.

5. A magnetically-coupled wireless power transfer system according to claim 2 wherein:
the plurality of transmitter magnets are symmetric about a transmitter bisecting plane that bisects an axial length of the transmitter rotor and is orthogonal to the transmitter axis; and
the plurality of receiver magnets are symmetric about a receiver bisecting plane that bisects an axial length of the receiver rotor and is orthogonal to the receiver axis.

6. A magnetically-coupled wireless power transfer system according to claim 5 wherein the magnetization directions of the transmitter magnets on a first side of the transmitter bisecting plane are one of: monotonically increasing or monotonically decreasing as the transmitter magnets approach the transmitter bisecting plane, so that the offset between adjacent transmitter magnets on the first side of the transmitter bisecting plane is in the same angular direction for each pair of adjacent transmitter magnets on the first side of the transmitter bisecting plane.

7. A magnetically-coupled wireless power transfer system according to claim 2 wherein:
a majority of the plurality of transmitter magnets on each side of a transmitter bisecting plane that bisects an axial length of the transmitter rotor and is orthogonal to the transmitter axis are symmetric with one another; and
a majority of the plurality of receiver magnets on each side of a receiver bisecting plane that bisects an axial length of the receiver rotor and is orthogonal to the receiver axis are symmetric with one another.

8. A magnetically-coupled wireless power transfer system according to claim 2 wherein the plurality of transmitter magnets has an odd number of magnets, m, and the offset angle, β, is determined according to:
$$α = \frac{360 °}{m + 1} .$$

9. A magnetically-coupled wireless power transfer system according to claim 2 wherein the plurality of transmitter magnets has an even number of magnets, m, and the offset angle, β, is determined according to:
$$α = \frac{360 °}{m} .$$

10. A magnetically-coupled wireless power transfer system according to claim 1 wherein the plurality of receiver magnets comprises the same number of magnets as the plurality of transmitter magnets and the magnetization directions of the plurality of receiver magnets correspond to a 180° rotation of the wireless power transmitter about a bisecting axis, the bisecting axis bisecting an axial length of the wireless power transmitter and orthogonal to the transmitter axis.

11. A magnetically-coupled wireless power transfer system according to claim 1 wherein the plurality of receiver magnets comprises a different number of magnets than the plurality of transmitter magnets.

12. A magnetically-coupled wireless power transfer system comprising:
a transmitter rotor further comprising at least two magnets connected end-to-end and further arranged such that the magnetization directions of each of the magnets are offset by a defined angle with respect to each other; and
a receiver rotor further comprising at least two magnets connected end-to-end and further arranged such that the magnetization directions of each of the magnets are offset by a defined angle with respect to each other.

13. The magnetically-coupled wireless power transfer system of claim 12, wherein the magnetization directions of the magnets in the transmitter rotor or in the receiver rotor or in both the transmitter and receiver rotors are offset by about 1° to about 90° with respect to each other.

14. The magnetically-coupled wireless power transfer system of claim 12, wherein the magnetization directions of the magnets in the transmitter rotor or the in receiver rotor or both in the transmitter and receiver rotors are offset by about 90° with respect to each other.

15. The magnetically-coupled wireless power transfer system of claim 12, wherein the transmitter rotor is comprising three magnets and their magnetization directions are offset by about 90° with respect to each other.

16. The magnetically-coupled wireless power transfer system of claim 12, wherein the receiver rotor is comprising three magnets and their magnetization directions are offset by about 90° with respect to each other.

17. The magnetically-coupled wireless power transfer system of claim 12, wherein the receiver rotor and the transmitter rotor are each comprising three magnets and their magnetization directions are offset by about 90° with respect to each other.

18. Automobiles, transit buses, delivery vehicles, trucks, drones, boats, golf carts or other consumer devices comprising a magnetically-coupled wireless power transfer system according to claim 12.

19. A method for wireless transferring power from a transmitter rotor to a receiver rotor, the method comprising:
providing a wireless power transmitter rotor comprising a plurality of transmitter magnets each having a magnetization direction, the transmitter rotor rotatable about a transmitter axis and the plurality of transmitter magnets arranged adjacent to one another along the transmitter axis;
providing a wireless power receiver rotor comprising a plurality of receiver magnets each having a magnetization direction, the receiver rotor rotatable about a receiver axis and the plurality of receiver magnets arranged adjacent to one another along the receiver axis;
bringing the receiver rotor into proximity with the transmitter rotor; and
rotating the transmitter rotor about the transmitter axis to thereby cause opposing rotation of the receiver rotor about the receiver axis;
wherein a first one of the plurality of the transmitter magnets has a first magnetization direction and a second one of the plurality of transmitter magnets has a second magnetization direction, the second magnetization direction non-parallel with the first magnetization direction so that, during rotation of the transmitter rotor about the transmitter axis, magnetic attraction of the first transmitter magnet to the receiver rotor is maximized at a first rotational position of the transmitter rotor about the transmitter axis and magnetic attraction of the second transmitter magnet to the receiver rotor is maximized at a second rotational position of the transmitter rotor about the transmitter axis different than the first rotational position.

20. A method according to claim 19 or any other claim herein comprising:
locating the first and second transmitter magnets to be axially adjacent to one another;
orienting the first and second magnetization directions to be offset by a transmitter offset angle about the transmitter axis relative to one another;
wherein the plurality of receiver magnets comprise first and second receiver magnets spaced apart from the first and second transmitter magnets in a direction orthogonal to the transmitter axis, the first and second receiver magnets being axially adjacent to one another and having magnetization directions offset by a receiver offset angle about the receiver axis relative to one another.
